(19) United States
(12) Patent Application Publication
(10) Pub. No.: US 2005/0053374 A1
(43) Pub. Date: Mar. 10, 2005

(54) Error propagation and signal path protection in optical network

(76) Inventor: Sten Hubendick, Stockholm (SE)

Correspondence Address: LADAS & PARRY LLP, 224 SOUTH MICHIGAN AVENUE, SUITE 1200, CHICAGO, IL, 60604, US

(21) Appl. No.: 10/504,049

(22) PCT Filed: Feb. 12, 2003
(86) PCT No.: PCT/SE03/00230

(30) Foreign Application Priority Data
Feb. 27, 2002 (SE) 0200585-8

(51) Int. Cl. H04J 14/00

(52) U.S. Cl. 398/50

(57) ABSTRACT

A method and a device in a cross-connector node in an optical network for error propagation and signal path protection including supervision of incoming signal on input port, switching off of output port at loss of signal, alteratively switching so that output port is connected to signal source being part of protected path, and restart respective reconnection at detection of recurred signal.

### TECHNICAL FIELD

The present invention relates to error propagation and signal path protection in optical communication networks.

### PRIOR ART

At a fiber break or at error in a laser in a static optical network, the error will propagate through the network by itself. Transponders propagate/transmit the error by switching off themselves when they have no incoming light. In a completely optical network the light is not regenerated; consequently the error there will propagate in a natural way. Thus, the loss of signal will be detectable further on along the transmission path. If, on the other hand, there are electro-optical cross-connectors in the network, more logic is required to make the error propagate. The laser in a transceiver is not switched off automatically. Besides, the signal will have its input into a cross-connector by one of several Rx-ports (reception ports) and its output by one or more Tx-ports (transmission ports).

The aim of the present invention is to provide a method to achieve that a signal error, which has been detected in the optical network, propagates in the transmission direction, to at that make it possible to be detected by subsequent nodes in the network and by that make switching off/disconnection of related transmission ports possible, alternatively achieve that related cross-connectors perform so called protection switching.

### SUMMARY OF THE INVENTION

The invention relates to a method and an arrangement in a cross-connection node in an optical network including supervision of incoming signal on input port, switching off/disconnection of output port at loss of signal, alternatively switching so that output port is interconnected with signal source being part of protection path, and restart respective re-switching at detection of recurred signal.

The invention is defined in the patent claims. Preferred embodiments are defined in the subclaims.

### BRIEF DESCRIPTION OF THE DRAWINGS

The invention is described in detail below with reference to the figures below, of which:

FIG. 1 shows a cross-connector node with control logic;

FIG. 2 shows signal propagation via a primary signal path in an optical network with a number of letter-marked nodes;

FIG. 3 shows the network in FIG. 1 inclusive a protection signal path; and

FIG. 4-8 show error propagation and events if an error occurs.

FIG. 4:

A=An error occurs, i.e. the laser fails in node c, or the fiber between c and d is broken/cut. Signal detection at input port of node d detects loss of signal.

FIG. 5:

B=Propagate the error, i.e. find laser to which input port is connected and switch off.

FIG. 6:

C=Propagate the error, i.e. find laser to which input port is connected and switch off.

FIG. 7:

D=Propagate the error, i.e. find laser to which input port is connected and switch off.

FIG. 8:

E=This is the last node in the path. Perform cross-connection to protection path. Don't switch off the laser!

FIG. 9 shows a cross-connector node and control logic according to one embodiment of the invention;

FIGS. 10a-d and 11 show a flow chart for a method according to one preferred embodiment of the invention.

FIG. 10a:

A=Input signal lost/lacking ?

B=Initiate timer

C=Store input port ID

D=Store output port ID

E=Timer period expired ?

F=Input signal still lost/lacking ?

G=Output port is end port in protected path

H=Connect input port from protected path to output port

I=output port is part of protected path ?

J=switch off output port (i.e. the laser)

FIG. 10b:

K=Output port is end port in primary path ?

L=Output port is part of primary path ?

M=Switch off output port (i.e. the laser)

FIG. 10c:

N=Signal back ?

O=Initiate timer

P=Timer period expired ?

Q=Signal still on/in existence ?

R=Output port is end port in protected path ?

S=Connect input port from protected path to output port

T=Output port is part of protected path ?

U=Switch on output port (i.e. the laser)

FIG. 10d:

V=Output port is end port in primary path ?

W=Output port is part of primary path ?

X=Switch on output port

FIG. 11:

A=Start. Input Port is the input port which is connected to this Output Port. Prot. Port is defined if this is end port in primary path.

B=Input signal not existing/lacking from input port ?

C Initiate timer

D=Timer period expired ?

E=Input signal not existing/lacking from input port ?

F=This output port is end port in primary path

G=Connect input port from protection path to output port (connect Prot. Port to Output Port)

H=This output port is part of primary path ?

I=Switch off laser of Output Port

### DETAILED DESCRIPTION OF PREFERRED EMBODIMENTS

The present invention relates to error detection and signal error propagation in networks with opto-electrical cross-connectors where one wants to have the possibility to propagate loss of signal and possibly perform 1+1-protection. The invention includes a method to detect loss of signal at inputs to cross-connector nodes, transmission of loss of signal to outputs of cross-connector nodes, and decision method and control method for performing of protection switching for protected signal paths.

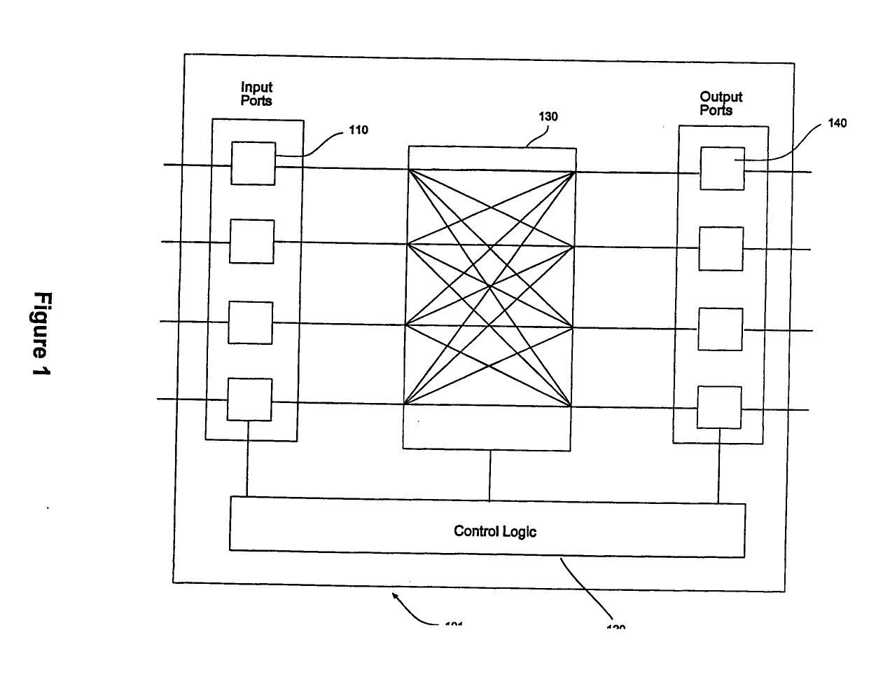

One preferred embodiment is described here with reference to FIG. 1. FIG. 1 shows a cross-connector node 101 with a control logic 120 which is connected to and controls a number of input ports 110 and a number of output ports 140. Between the input ports 110 and the output ports 140, a switch matrix 130 is arranged which also is connected to the control logic and which makes possible that just any input port can be connected to just any output port, controlled from the control logic 120. In the case that a signal on an input port 110 disappears, this dropout is detected and the control logic 120 in the cross-connector node 101 checks which output port/ports 140 that are interconnected with said input port 110 in the switch matrix 130, and switches off these output ports 140, or alternatively performs protection switching.

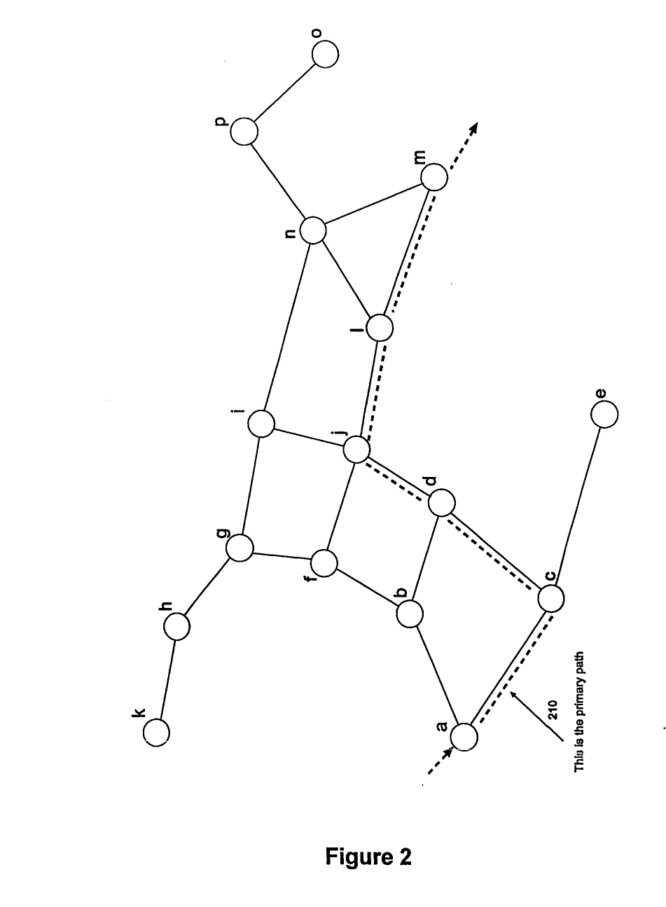

The function is shown in the example in FIGS. 2-8.

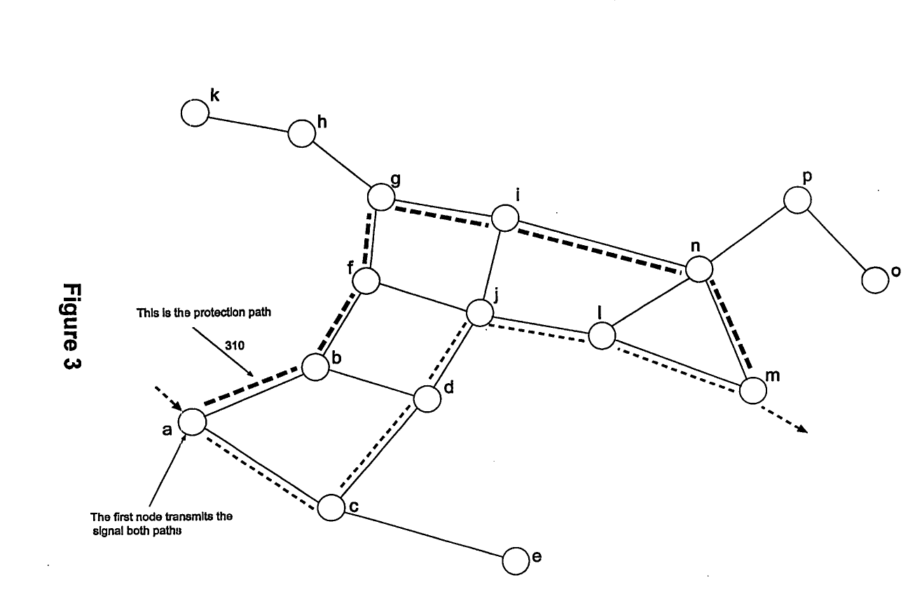

FIG. 2 shows a primary signal path 210 which extends over the nodes a-c-d-j-l-m. FIG. 3 shows a redundant signal path 310 which extends over the nodes a-b-f-g-i-n-m; the first node a) transmits the signal both paths, that is, both to node b) and node c). The fact that a redundant signal path has been established results in that the primary path is called protected path.

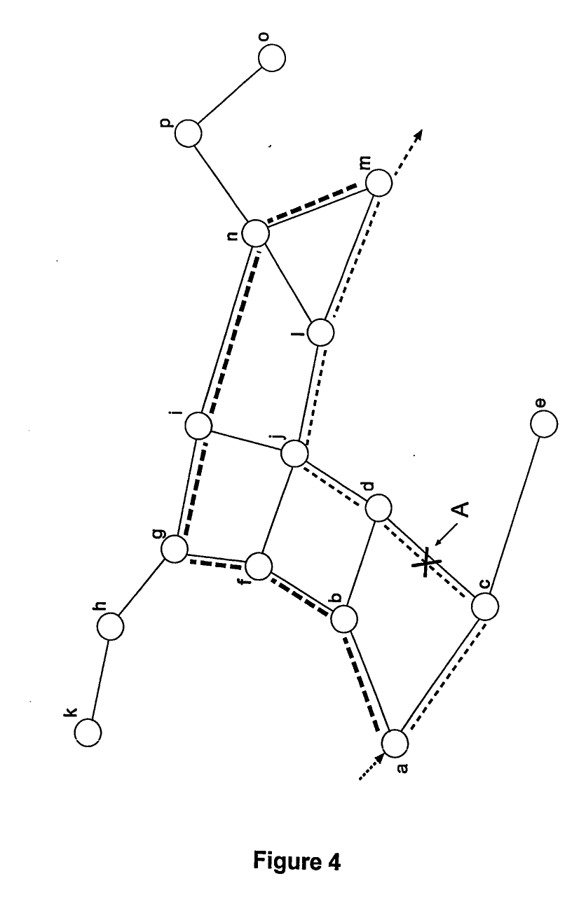

FIG. 4 shows what will happen if an error occurs on the path between node c) and node d). The error can, for instance, consist of that the transmitter laser in node c) fails, or that the optical fiber between node c) and node d) is cut/broken. A signal detection unit at input port in question at node d) detects the occurred loss of signal.

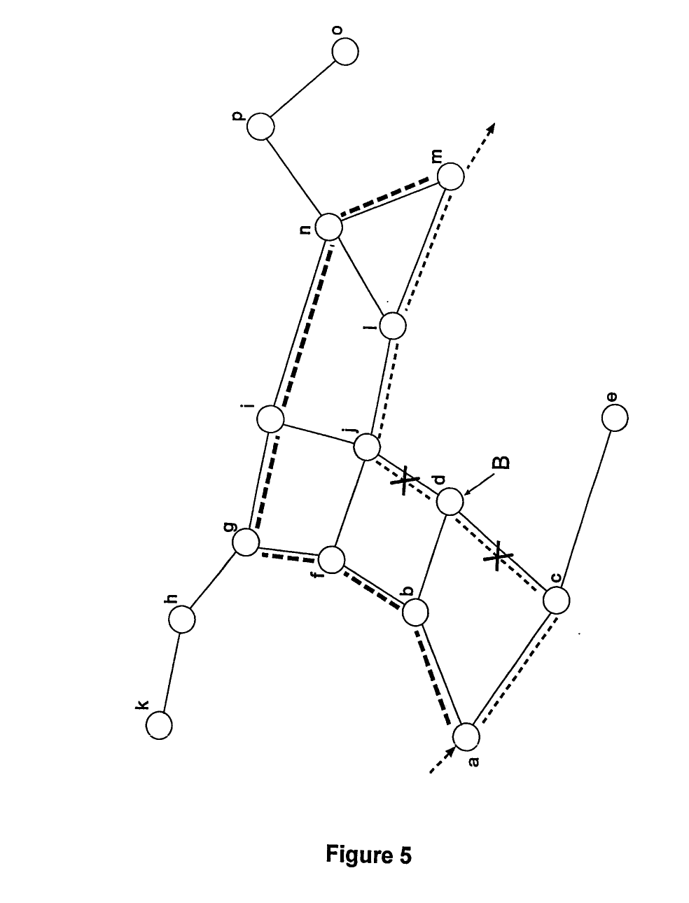

FIG. 5 shows how one embodiment of the invention by its influence in/effect on node d) propagates the error to the signal path between node d) and node j), that is, the transmitting laser which is connected to the input port which receives signal from node c) has been switched off.

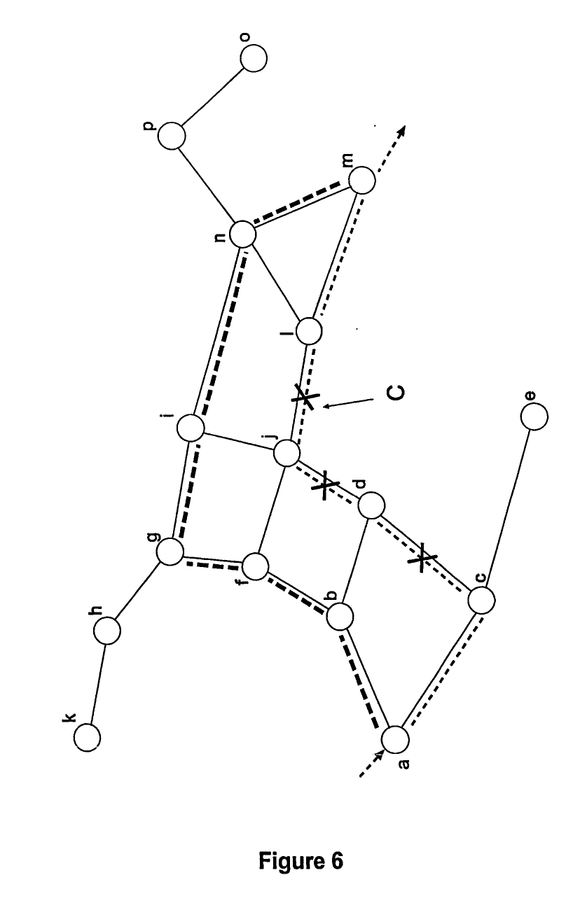

FIG. 6 shows how one embodiment of the invention by its influence in/effect on node j) propagates the error to the signal path between node j) and node l).

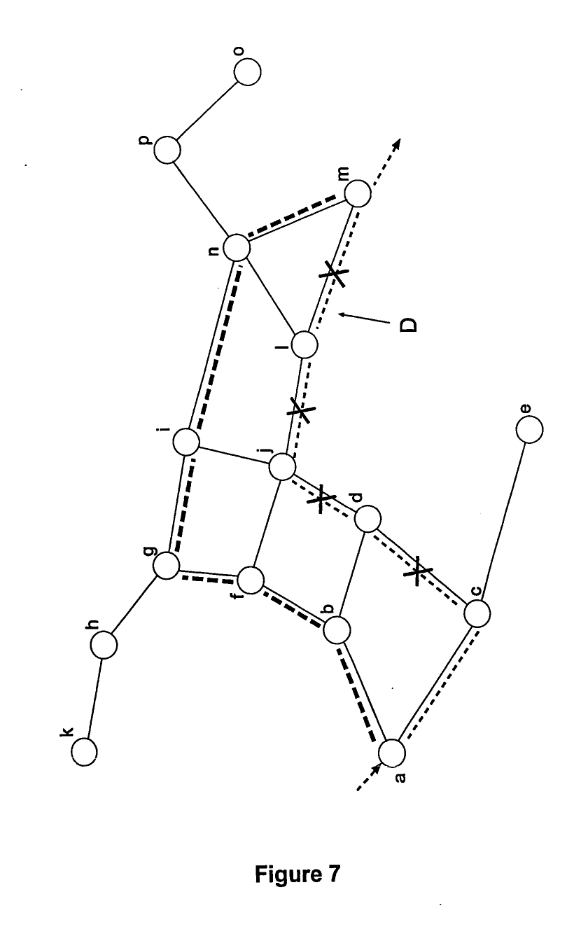

FIG. 7 shows how one embodiment of the invention by its influence in/effect on node l) propagates the error to the signal path between node l) and node m).

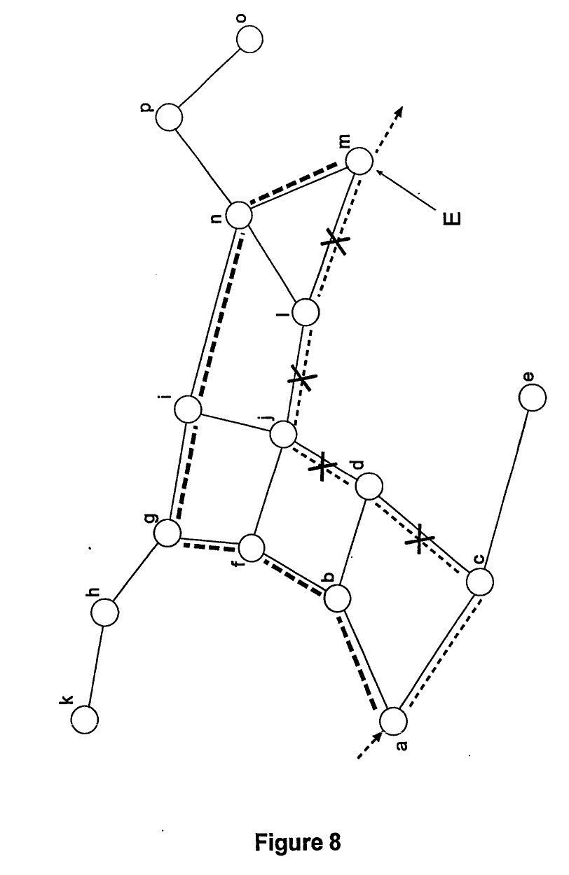

FIG. 8 shows how one embodiment of the invention by its influence in/effect on node m) detects the propagated error in the primary signal path 210 and instead connects signal from the protection path via the node n); transmitting laser is not switched off.

One arrangement according to one embodiment of the invention includes a set of units as below and should best be implemented as a computer program or in hardware, or as a mixture of them.

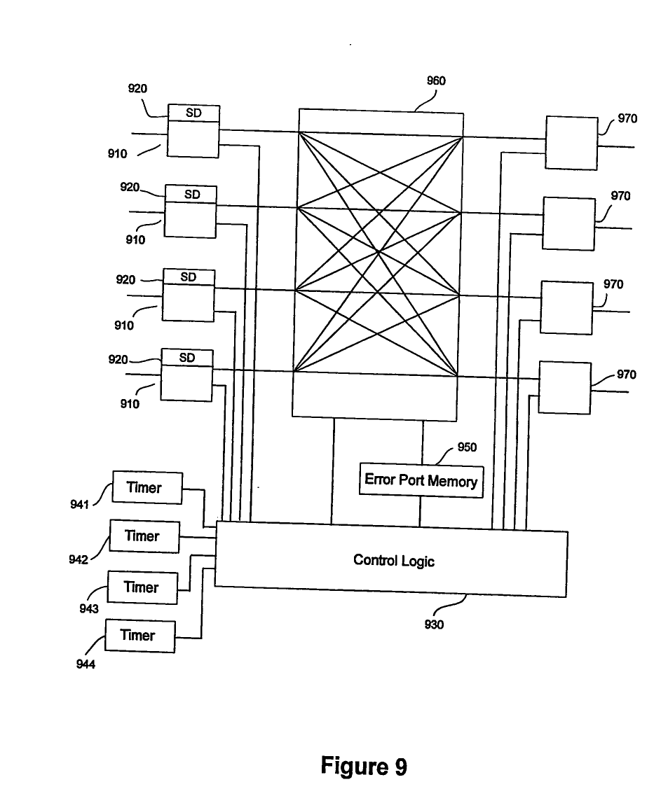

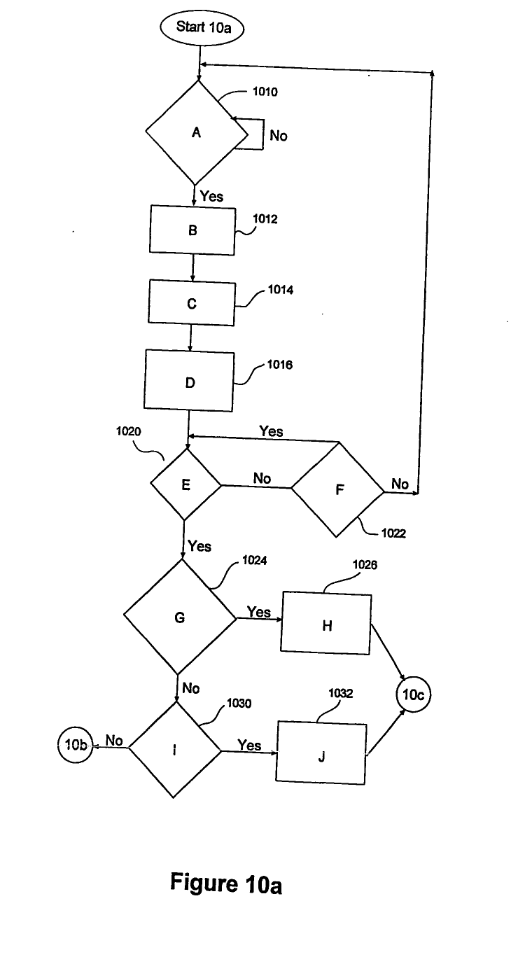

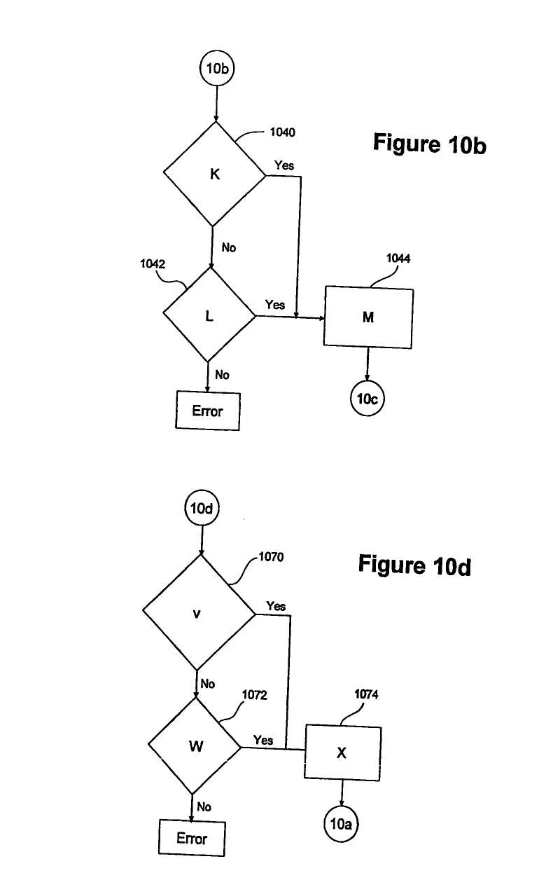

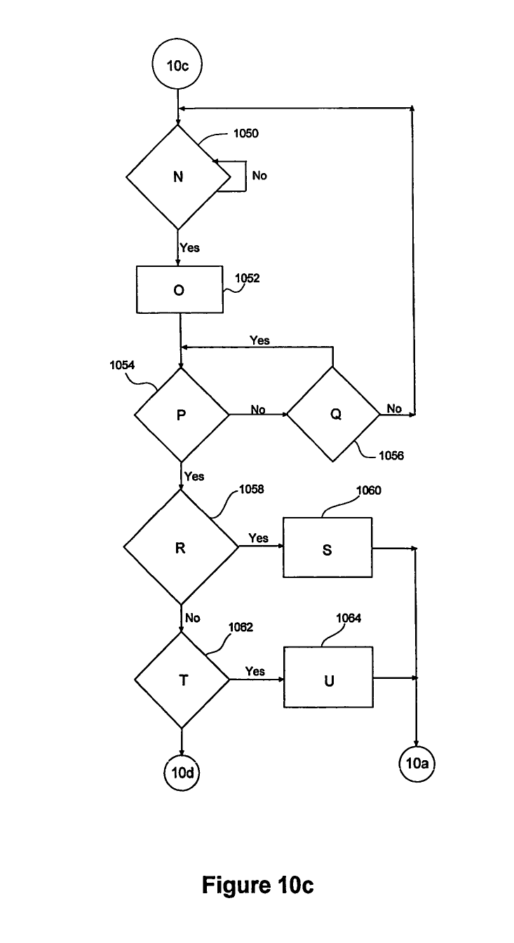

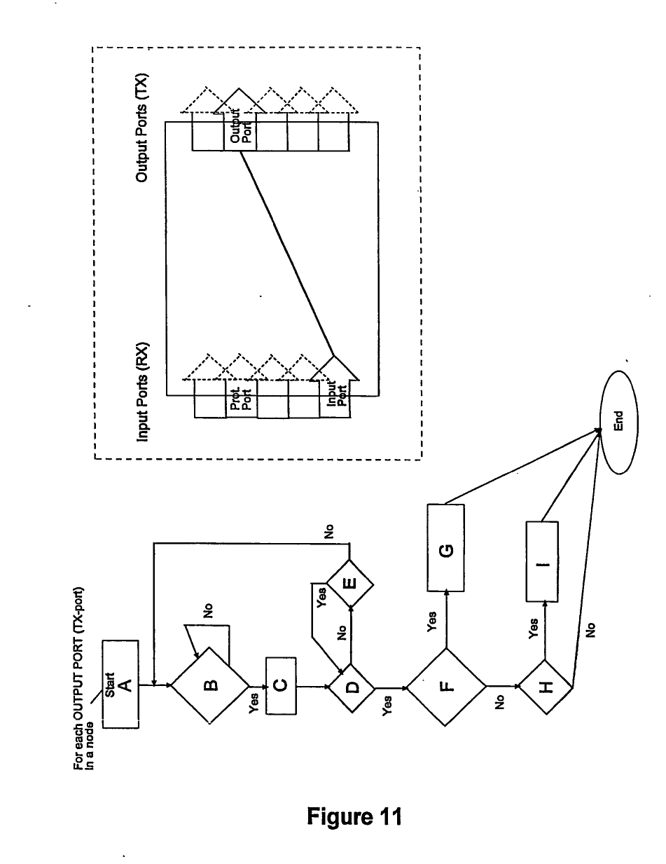

With reference to FIG. 9, a cross-connector node according to one embodiment of the invention is described. Each input port 910 is equipped with a signal detector 920, intended to detect existence of signal respective loss/lack of signal. Each signal detector is connected to a common control logic 930. The control logic is further connected to a number of timers 941-944, one for each input port. Further, the control logic is connected to an error port memory 950 for storing of identification code for the input ports which have a detected loss of signal and for storing of identification code for the output ports which are connected to these input ports with detected loss of signal. Each input port and each output port is connected to a switch matrix 960 in known way.

At operation of a device according to the invention the following steps are run through:
signal supervision of incoming signal on input port 1010,
initiation of a timer at loss of signal 1012,
storing of identification code for input ports with detected loss of signal 1014,
storing of identification code for output ports connected to input ports with detected loss of signal 1016,
supervision of time for loss of signal (control of timer) 1020
switching, at during specified time remaining loss/lack of signal, of protection input port to output port, if output port is end port in protected path 1024, 1026.
switching off, during certain time remaining loss of signal, of output port, that is laser, if output port is part of protected path 1030, 1032,
re-connection of input port being part of protected path to output port if output port is end port in protected path, at recurrence of signal from input port 1050-1060, and
switching-on of switched off laser when signal has recurred a certain smallest period of time 1050-1056, 1062, 1064, 1017-1074.

One preferred embodiment of the error detection of the cross-connector node is shown by the following algorithm:

Array: TXArray

Time-out-period: TIME

Rx-port: Rxn

Rx-port: Protection-Rx

1. “Signal Detect” (SD) for RXn high

2. Wait for SD low

3. Detection of loss of signal (SD low in Rxn-port)

4. Initiate timer

5. Tx-ports connected to Rxn-port with detected loss of signal−>TXArray

6. If loss of signal unchanged during a certain period of time TIME:
a. For each Tx-port in TXArray:
   i. if Tx-port is end port in protected path (that is, primary path)
      1. connect protection Rx-port to Tx-port
   ii. otherwise if Tx-port is part of protected path
      1. switch off Tx-port (laser) so that the error propagates

7.
a. Wait for SD high
b. SD high detected on Tx-port
c. Initiate timer
d. If SD high unchanged during a certain period of time TIME:
   i. for each Tx-port in TXArray:
      1. if each Tx-port is end port in protection path:
         a. connect Rxn-port to Tx-port
      2. otherwise if Tx-port is part of protection path:
         a. switch on Tx-port (laser) so that the signal propagates

8. Return to (1)

1. Method for error detection and signal path protection in optical communication networks comprising cross-connector nodes with input ports and output ports having lasers, comprising the following steps:
supervision an detection of signal loss of an incoming signal on input port of cross-connector node,
switching off/disconnection of the output port connected to said input port of the cross-connector at said loss of signal in the case the output port is part of protected path, wherein said disconnection of said output port comprises disconnection of the laser of said output port and
in the cross-connector node, connection of protection input port to the output port at said loss of signal in the case the output port is end port in protected path.

2. Method as claimed in claim 1, further including the step of:
in said cross-connector node, disconnection of the output port connected to said input port at said loss of signal in the case the output port is an end port or a part of an unprotected primary path.

3. Method as claimed in claim 2, further including the steps of:
in said cross-connector, reconnection/re-switching of input port being part of protected path to output port in the case said output port is end port in protected path and the signal at said input port has recurred,
switching on of switched off laser in the case the signal at the input port being part of primary signal path has recurred.

4. Cross connector node for an optical communication network, comprising input ports, output ports having lasers and a switch matrix, and signal detectors at each input port which detects loss of signal, if any, and communicates the loss of signal via one or more connections to a control logic, said control logic being connected to switch matrix and output ports and is devised with means for switching off the lasers of said output ports.

5. Device as claimed in claim 4, further comprising a set of timers connected with the control logic and intended to be started at loss of signal and signal to the control logic when this loss of signal has been the state for a certain period of time.

6. Device as claimed in claim 5 further comprising an error port memory connected to the control logic and intended to store information about which output ports that are connected to input ports with detected loss of signal.
